(19) United States
(12) Patent Application Publication
(10) Pub. No.: US 2025/0093520 A1
(43) Pub. Date: Mar. 20, 2025

(54) POSITIONING SYSTEM AND NON-TRANSITORY STORAGE MEDIUM

(71) Applicant: TOYOTA JIDOSHA KABUSHIKI KAISHA, Toyota-shi (JP)

(72) Inventors: Takayoshi YAMAZAKI, Miyoshi-shi (JP); Go HAYASHI, Toyota-shi (JP); Makoto ISHII, Tokyo-to (JP)

(73) Assignee: TOYOTA JIDOSHA KABUSHIKI KAISHA, Toyota-shi (JP)

(21) Appl. No.: 18/830,095

(22) Filed: Sep. 10, 2024

(30) Foreign Application Priority Data
Sep. 15, 2023 (JP) 2023-150277

(51) Int. Cl. G01S 19/13; H01Q 1/34

(52) U.S. Cl. CPC G01S 19/13; H01Q 1/34

(57) ABSTRACT

In the positioning system, a computing device obtains a first position measured by a first positioning antenna, a second position measured by a second positioning antenna, and a third position measured by a third positioning antenna. The computing device calculates the current attitude of the oscillating body at the first position from a first vector from the first position to the second position and the acquired second vector from the first position to the third position. The computing device modifies a reference vector from the first positioning antenna to the predetermined point in the attitude of the oscillating body at the predetermined time, according to the calculated current attitude of the oscillating body at the first position. The computing device then calculates the position of the predetermined point in the current attitude of the oscillating body by adding the modified reference vector to the first position.

### CROSS REFERENCE TO THE RELATED APPLICATION

This application claims the benefit of Japanese Patent Application No. 2023-150277, filed on Sep. 15, 2023, which is hereby incorporated by reference herein in its entirety.

### BACKGROUND

### Technical Field

The present disclosure relates to a positioning system and a positioning program.

### Description of the Related Art

Japanese Patent Laid-Open No. 2005-207831 discloses a posture detection device that detects a change in posture of a two-wheeled vehicle based on a GPS signal. The attitude detection device disclosed in Japanese Patent Laid-Open No. 2005-207831 includes a first GPS receiver provided at a first position on the vehicle and a second GPS receiver provided at a second position lower than the first position. The attitude detection device also determines first position information based on a GPS signal detected by the first GPS receiver, and determines second position information based on a GPS signal detected by the second GPS receiver. The attitude detection device detects the traveling direction of the vehicle, and detects a change in the attitude of the vehicle based on the first and second position information and the traveling direction of the vehicle.

Japanese Patent Laid-Open No. 2008-298443 discloses a multipath detection device that detects whether multipath waves are included in each carrier wave transmitted from each GPS satellite and received by each GPS antenna in a mobile body in which multiple GPS antennas are installed with the relative positions between the GPS antennas fixed. The multipath detection device disclosed in Japanese Patent Laid-Open No. 2008-298443 inputs carrier phase information indicating the distance between each GPS satellite and each GPS antenna in terms of the number of carrier waves, and uses a CPU to calculate the difference in carrier phase between the same GPS satellite and the GPS antennas based on the input carrier phase information.

The multipath detection device inputs the calculated carrier phase difference between the GPS antennas and a Line Of Sight (LOS) vector indicating the direction from a specific GPS antenna to a specific GPS satellite specified by an arbitrary method, and uses a CPU to calculate a baseline length indicating the distance between the GPS antennas as an observation baseline length based on the input carrier phase difference and the input LOS vector. The multipath detection device uses a CPU to compare a known baseline length, which indicates a pre-calculated distance between GPS antennas, with the observed baseline length, and if the observed baseline length differs from the known baseline length by more than a predetermined threshold value, determines that multipath waves are included in each carrier wave used to calculate the observed baseline length.

### SUMMARY

An object of the present disclosure is to grasp the state of a predetermined point of an oscillating body.

A positioning system, according to a first aspect of the present disclosure, comprises a first positioning antenna, a second positioning antenna and a third positioning antenna attached to an oscillating body,
and a computing device, wherein
the computing device is configured to execute;
   acquiring a first position measured by the first positioning antenna, a second position measured by the second positioning antenna, and a third position measured by the third positioning antenna,
   calculating a current attitude of the oscillating body at the first position from a first vector from the first position to the second position and a second vector from the first position to the third position,
   modifying a reference vector from the first positioning antenna to a predetermined point in the attitude of the oscillating body at a predetermined time in accordance with the calculated current attitude of the oscillating body at the first position, and
   calculating a position of the predetermined point in the current attitude of the oscillating body by adding the modified reference vector to the first position.

A non-transitory storage medium, according to a second aspect of this disclosure, stores a positioning program that causes a computing device connected to a first positioning antenna, a second positioning antenna, and a third positioning antenna attached to an oscillating body to execute an information processing method, wherein
the information processing method includes;
   acquiring a first position measured by the first positioning antenna, a second position measured by the second positioning antenna, and a third position measured by the third positioning antenna,
   calculating a current attitude of the oscillating body at the first position from a first vector from the first position to the second position and a second vector from the first position to the third position,
   modifying a reference vector from the first positioning antenna to a predetermined point in the attitude of the oscillating body at a predetermined time in accordance with the calculated current attitude of the oscillating body at the first position, and
   calculating a position of the predetermined point in the current attitude of the oscillating body by adding the modified reference vector to the first position.

According to the present disclosure, it is possible to grasp the state of a predetermined point of an oscillating body.

### BRIEF DESCRIPTION OF THE DRAWINGS

FIG. 1 is a diagram showing a schematic configuration of a positioning system.

FIG. 2 is a diagram showing an example of changes in the positions of each antenna and a predetermined point when a ship is oscillating;

FIG. 3 is a block diagram illustrating an example of a functional configuration of a computing device;

FIG. 4 is a diagram illustrating an example of a table configuration of location information stored in a location information database;

FIG. 5 is a flowchart of a first process executed by a controller in the computing device; and

FIG. 6 is a flowchart of a second process executed by a controller in the computing device.

### DESCRIPTION OF THE EMBODIMENTS

Assume that the position of a predetermined point of a oscillating body is to be calculated. At this time, even if the oscillating body is not moving, it is expected that the position of the predetermined point will change due to the oscillation of the oscillating body. In other words, it is assumed that the position of the predetermined point of the oscillating body changes depending on the attitude of the oscillating body. Therefore, it becomes difficult to accurately grasp the position of a predetermined point of the oscillating body. Therefore, the positioning system according to the first aspect of the present disclosure solves such a problem.

A positioning system according to a first aspect of the present disclosure is a system including a first positioning antenna, a second positioning antenna, and a third positioning antenna attached to a oscillating body, and a computing device. A computing device in a positioning system according to a first aspect of the present disclosure acquires a first position, a second position, and a third position. Here, the first position, the second position, and the third position are positions measured by the first positioning antenna, the second positioning antenna, and the third positioning antenna, respectively.

The computing device calculates the current attitude of the oscillating body at the first position from the first vector and the second vector. Here, the first vector is a vector from the first position to the second position. Moreover, the second vector is a vector from the first position to the third position. The computing device modifies the reference vector from the first positioning antenna to the predetermined point in the attitude of the oscillating body at the predetermined time, according to the calculated current attitude. Here, a given vector from the first positioning antenna to a predetermined point in a given attitude of the oscillating body at a predetermined time is defined as a reference vector.

The modified reference vector is a vector from the first position to the current predetermined point (a vector to the predetermined point with the first position as a reference). Therefore, the computing device calculates the position of the predetermined point in the current attitude of the oscillating body by adding the first position to the modified reference vector.

As described above, the information processing device can calculate the position of a predetermined point that is affected by the oscillation of the oscillating body, using the positions of three points on the oscillating body measured by three positioning antennas. In this way, it becomes possible to grasp the state of a predetermined point of the oscillating body.

Hereinafter, specific embodiments of the present disclosure will be described with reference to the drawings. Unless otherwise specified, the hardware configuration, module configuration, functional configuration, and the like described in each embodiment are not intended to limit the technical scope of the disclosure to only those.

### First Embodiment

### System Overview

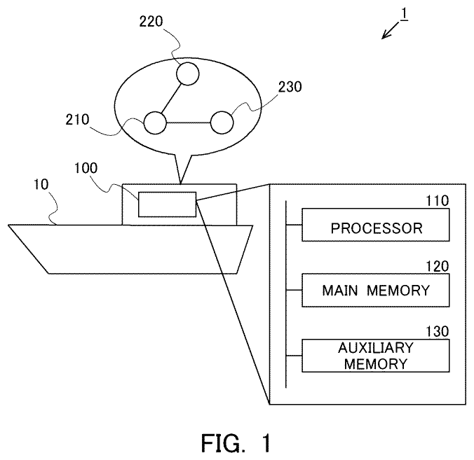

A positioning system 1 according to the present embodiment will be described with reference to FIG. 1. FIG. 1 is a diagram showing a schematic configuration of a positioning system 1. The positioning system 1 includes a computing device 100, a first antenna 210, a second antenna 220, and a third antenna 230. In the positioning system 1, a first antenna 210, a second antenna 220, and a third antenna 230 are connected to the computing device 100.

### (Antenna)

The first antenna 210, the second antenna 220, and the third antenna 230 are positioning antennas attached to the ship 10. The first antenna 210, the second antenna 220, and the third antenna 230 are, for example, GNSS positioning antennas. The first antenna 210, the second antenna 220, and the third antenna 230 can measure the current positions of the first antenna 210, the second antenna 220, and the third antenna 230. The current positions measured by the first antenna 210, the second antenna 220, and the third antenna 230 are, for example, their respective latitude, longitude, and altitude.

In this embodiment, the first antenna 210, the second antenna 220, and the third antenna 230 are attached to the upper surface of the ship 10. This makes it possible to prevent the first antenna 210, the second antenna 220, and the third antenna 230 from being unable to receive radio waves from the GNSS satellites. It should be noted that the first antenna 210, the second antenna 220, and the third antenna 230 do not necessarily have to be mounted horizontally on the ship 10.

### (Calculation Device)

The computing device 100 is a device that calculates the position (latitude, longitude, and altitude) of a predetermined point of the ship 10. Here, the predetermined point is an arbitrary point of the ship 10. The predetermined point is, for example, a point on the surface of the ship 10. The predetermined point may also be, for example, a point inside the ship 10.

The computing device 100 is connected to a first antenna 210, a second antenna 220, and a third antenna 230. The computing device 100 acquires the current position of the first antenna 210 measured by the first antenna 210 (hereinafter, may be referred to as the “first position”) from the first antenna 210. Furthermore, the computing device 100 acquires from the second antenna 220 the current position of the second antenna 220 measured by the second antenna 220 (hereinafter, may be referred to as the “second position”). Furthermore, the computing device 100 acquires from the third antenna 230 the current position of the third antenna 230 measured by the third antenna 230 (hereinafter, may be referred to as the “third position”).

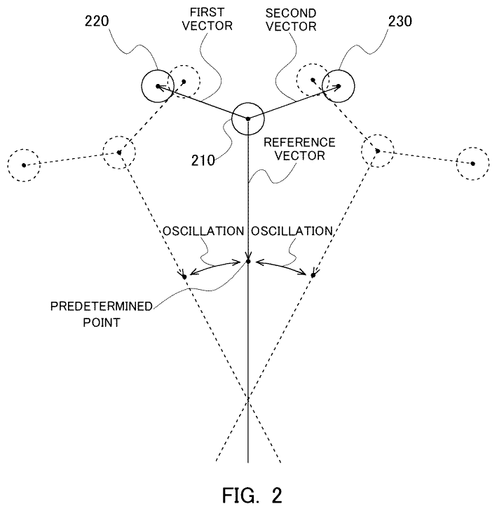

FIG. 2 is a diagram showing an example of changes in the positions of the antennas and the predetermined points when the ship 10 is oscillating. FIG. 2 shows how the positions (first position, second position, and third position) of the first antenna 210, the second antenna 220, and the third antenna 230 change due to the oscillation of the ship 10. In FIG. 2, the first antenna 210, the second antenna 220, the third antenna 230, the first vector (described later), the second vector (described later), and the reference vector (described later) are drawn in solid lines when the ship 10 is not oscillating. In addition, in FIG. 2, the first antenna 210, the second antenna 220, the third antenna 230, the first vector, the second vector, and the reference vector when the ship 10 is oscillating are drawn by dashed lines. As shown in FIG. 2, the first position, the second position, the third position, and the predetermined point change as the ship 10 oscillates.

The computing device 100 calculates a first vector and a second vector. Here, the first vector is a vector from the first position to the second position. Moreover, the second vector is a vector from the first position to the third position. Then, the computing device 100 calculates the current attitude of the ship 10 at the first position using the first vector and the second vector. Specifically, the computing device 100 calculates the roll, pitch, and yaw of the first position.

Here, a reference vector is predefined for a given point on the ship 10. The reference vector is a vector from the first antenna 210 to a predetermined point at an attitude of the ship 10 at predetermined time. Here, the attitude at the predetermined time is, for example, the attitude at a time when the ship 10 is not oscillating. In other words, the attitude at the predetermined time is the attitude when the roll, pitch, and yaw in the first position are zero. The computing device 100 modifies the reference vector according to the current attitude of the ship 10 at the first position (the current attitude including the roll, pitch, and yaw at the first position). Then, the computing device 100 calculates the position of the predetermined point using the modified reference vector and the first position. The method by which the computing device 100 modifies the reference vector and calculates the position of the predetermined point will be described in detail later.

The computing device 100 includes a computer having a processor 110, a main memory 120, and an auxiliary memory 130. The processor 110 is, for example, a central processing unit (CPU) or a digital signal processor (DSP). The main memory 120 is, for example, a RAM (Random Access Memory). The auxiliary memory 130 is, for example, a ROM (Read Only Memory). The auxiliary memory 130 is, for example, a HDD (Hard Disk Drive), or a disk recording medium such as a CD-ROM, a DVD disk, or a Blu-ray disk. The auxiliary memory 130 may be a removable medium. Here, examples of removable media include a USB memory and an SD card.

In the computing device 100, the auxiliary memory 130 stores an operating system (OS), various programs, various information tables, and the like. Furthermore, in the computing device 100, the processor 110 can realize various functions, which will be described later, by loading a program stored in the auxiliary memory 130 into the main memory 120 and executing it. However, some or all of the functions of the computing device 100 may be realized by a hardware circuit such as an ASIC or an FPGA. The computing device 100 does not necessarily have to be realized by a single physical configuration, but may be realized by a plurality of computers that work in cooperation with each other.

### (Functional Configuration)

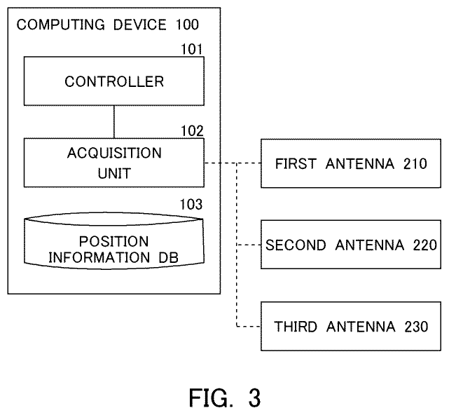

Next, the functional configuration of the computing device 100 constituting the positioning system 1 will be described with reference to FIG. 3. FIG. 3 is a block diagram illustrating an example of a functional configuration of the computing device 100.

The computing device 100 includes a controller 101, an acquisition unit 102, and a position information database 103 (position information DB 103). The controller 101 has a function of performing arithmetic processing for controlling the computing device 100. The controller 101 can be realized by the processor 110 in the computing device 100. The acquisition unit 102 has a function of acquiring the current positions from the first antenna 210, the second antenna 220, and the third antenna 230. The acquisition unit 102 also has a function of acquiring the amount of movement of the ship 10 from the drive control device of the ship 10. The acquisition unit 102 can be realized by an interface for connecting the computing device 100 to an external device (each antenna and drive control device).

The controller 101 acquires the current positions (first position, second position, and third position) of the first antenna 210, the second antenna 220, and the third antenna 230, respectively, by the acquisition unit 102. The controller 101 calculates a first vector using the first position and the second position. Furthermore, the controller 101 calculates a second vector using the first position and the third position. In this embodiment, each component of the first vector and the second vector is set using a coordinate system of latitude, longitude, and altitude.

The controller 101 calculates the roll, pitch, and yaw of the first position using the first vector and the second vector, thereby calculating the current attitude of the ship 10 at the first position. Here, in this embodiment, the roll, pitch, and yaw of the first position are determined by angles around the latitudinal axis, the longitudinal axis, and the altitude axis with the first position as the reference (origin) using latitude, longitude, and altitude as a coordinate system. Then, the controller 101 modifies the reference vector in accordance with the calculated current attitude of the ship 10 at the first position.

Now assume that the current attitude of the ship 10 at a first position is represented by a roll with a roll angle r, a pitch with a pitch angle p, and a yaw with a yaw angle h. The modified reference vector (x′, y′, z′) is expressed by the following equation using the rotation matrices for the roll angle r, pitch angle p, and yaw angle h, and the reference vector before correction (x, y, z). Here, the reference vector is defined by a coordinate system defined by latitude, longitude, and altitude.

$$( equation 1 )$$

$$( \begin{matrix}{x}^{′} \\ {y}^{′} \\ {z}^{′}\end{matrix} ) = ( \begin{matrix}1 & 0 & 0 \\ 0 & cos r & - sin r \\ 0 & sin r & cos r\end{matrix} ) ( \begin{matrix}cos p & & - sin p \\ 0 & 1 & 0 \\ sin p & 0 & cos p\end{matrix} ) ( \begin{matrix}cos h & - sin h & 0 \\ sin h & cos h & 0 \\ 0 & 0 & 1\end{matrix} ) ( \begin{matrix}x \\ y \\ z\end{matrix} )$$

The modified reference vector (x′, y′, z′) is a vector from the first position to the current predetermined point using the latitude, longitude, and altitude as a coordinate system. Therefore, the controller 101 calculates the current position of the predetermined point by adding each component of the coordinates of the first position to each component of the modified reference vector (x′, y′, z′).

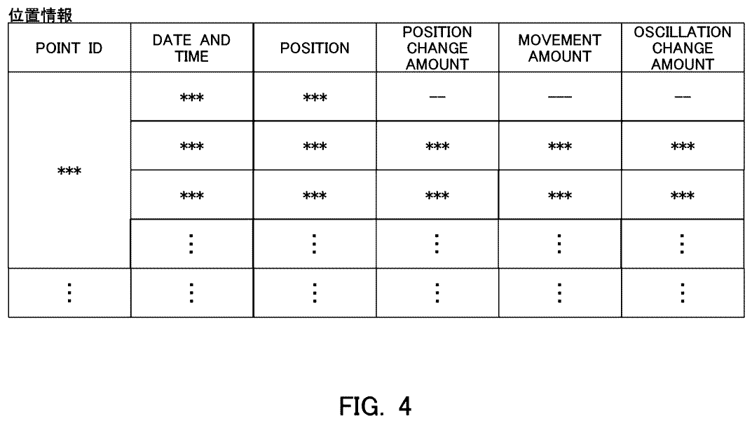

The location information DB 103 has a function of storing location information. The position information DB 103 can be realized by the auxiliary memory 130 in the computing device 100. When the controller 101 calculates the current position of the predetermined point, it updates the position information held in the position information DB 103. The position information is information relating to the calculated current position of the predetermined point. FIG. 4 is a diagram showing an example of a table configuration of the location information stored in the location information DB 103.

As shown in FIG. 4, the position information has a point ID field, a date and time field, a position field, a position change amount field, a movement amount field, and an oscillation change amount field. The point ID field stores an identifier (point ID) for identifying a predetermined point of the ship 10. In the position information, point IDs for a plurality of predetermined points are stored.

The date and time field stores information indicating the date and time when the controller 101 calculates the position of the predetermined point. The date and time fields store information indicating the oldest date and time from the top. The position field stores the position of the predetermined point calculated by the controller 101 at the date and time indicated by the information stored in the date and time field.

The position change amount field calculates the amount of change in the position of a predetermined point during the time (hereinafter sometimes referred to as a “specific time”) between the date and time indicated by the information stored in the corresponding date and time field and the date and time indicated by the information stored in the date and time field one level above the corresponding date and time field. Here, the amount of change in the position of a given point is calculated by subtracting the position of the given point stored in the position field one position above the corresponding position field from the position of the given point stored in the corresponding position field. Here, the amount of change in the position of a given point is the amount of change in each of the latitude, longitude, and altitude components.

The movement amount field stores the movement amount of the ship 10 at a specific time. The controller 101 obtains the speed of the ship 10 from the drive control device of the ship 10. Here, the speed of the ship 10 acquired by the controller 101 is the speed in each of the latitude direction, longitude direction, and altitude direction. Then, the controller 101 calculates the amount of movement of the ship 10 based on the speed of the ship 10. Specifically, the controller 101 calculates the amount of movement by multiplying the acquired speed by the specific time. When the speed of the ship 10 is changing at a specific time, the integral value of the speed at the specific time may be calculated as the amount of movement of the ship 10.

The amount of change in the position of a predetermined point stored in the position change amount field includes the amount of change in position due to the oscillation of the ship 10 and the amount of change in position due to the movement of the ship 10.

Therefore, by removing the amount of change in position due to the movement of the ship 10 from the amount of change in position of a predetermined point, the amount of change in position due to the oscillation of the ship 10 can be calculated. Therefore, the controller 101 calculates the amount of change in position due to the oscillation of the ship 10 by subtracting the amount of movement of the ship 10 stored in the movement amount field from the amount of change in position of the ship 10 stored in the position change amount field. Then, the controller 101 stores information indicating the calculated amount of change in position due to the oscillation of the ship 10 in the oscillation change amount field.

Here, it is assumed that the center of buoyancy of the ship 10 will change depending on the arrangement or amount of luggage loaded on the ship 10 or the people on board the ship 10. Furthermore, the center of buoyancy is assumed to be the position where change in position due to oscillation of the ship 10 is the smallest. Therefore, the controller 101 refers to the transition of the amount of change due to the oscillation of the ship 10, and identifies a predetermined point where the amount of position change due to the oscillation of the ship 10 is the smallest as the center of buoyancy of the ship 10.

Specifically, the controller 101 acquires the location information stored in the location information DB 103. The controller 101 counts the amount of change in position due to the oscillation of the ship 10, which is stored in the oscillation change amount field in the position information, for each point ID, and calculates a count value. The controller 101 identifies, for example, the point ID with the smallest amount of change in position due to the oscillation of the ship 10. The controller 101, for example, obtains the amount of change in each direction and calculates the absolute value. That is, the controller 101 calculates the distance of change of a predetermined point due to the oscillation. Then, a predetermined point at which the amount of change in position due to the oscillation of the ship 10 is minimal is identified as the center of buoyancy of the ship 10.

### (First Process)

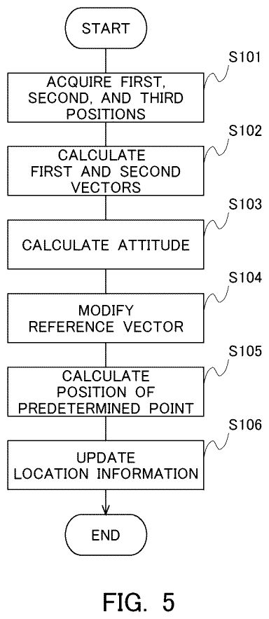

Next, a first process executed by the controller 101 in the computing device 100 in the positioning system 1 will be described with reference to FIG. 5. FIG. 5 is a flowchart of a first process executed by the controller 101 in the computing device 100. The first process is a process for calculating the position of a predetermined point of the ship 10. The first process is repeatedly executed at predetermined intervals. In the first process, first, in S101, the first position, the second position, and the third position are acquired from the first antenna 210, the second antenna 220, and the third antenna 230, respectively. Next, in S102, a first vector and a second vector are calculated using the first position, the second position, and the third position. Next, in S103, the attitude of the ship 10 at the first position is calculated using the first vector and the second vector. Next, in S104, the reference vector is modified using the attitude of the ship 10 at the first position. Next, in S105, the position of the predetermined point is calculated using the modified reference vector and the first position. Next, in S106, the location information held in the location information DB 103 is updated. Then, the first process is temporarily terminated.

### (Second Processing)

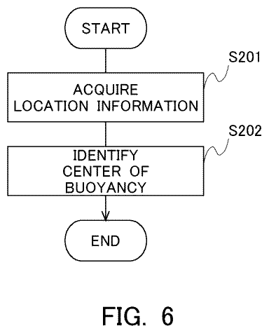

The second process executed by the controller 101 in the computing device 100 in the positioning system 1 will be described with reference to FIG. 6. FIG. 6 is a flowchart of a second process executed by the controller 101 in the computing device 100. The second process is a process for calculating the center of buoyancy of the ship 10. The second process starts to be executed at a predetermined timing. The predetermined timing is, for example, when the manager of the ship 10 instructs the computing device 100 to execute the second process. The predetermined timing may also be a timing when a predetermined time has elapsed since the ship 10 departs. Furthermore, the predetermined timing may occur repeatedly.

In the second process, first, in S201, the location information held in the location information DB 103 is obtained. Next, in S202, the position information is referenced, and a predetermined point where the amount of change in position due to the oscillation of the ship 10 is the smallest is identified as the center of buoyancy of the ship 10. Then, the second process ends.

As described above, in the positioning system 1, the position of the predetermined point is calculated from the current positions of the first antenna 210, the second antenna 220, and the third antenna 230. This makes it possible to grasp the position of a predetermined point that is affected by the oscillation of the ship 10. Furthermore, if the predetermined point is a point on the surface of the ship 10, it is possible to calculate the distance between the surface of the ship 10 and another object (e.g., a quay, etc.). As a result, it is possible to prevent the ship 10 from coming into contact with other objects due to the oscillation of the ship 10. In addition, the center of buoyancy of the ship 10 can be identified based on the amount of change in the position of a predetermined point due to the oscillation of the ship 10. In other words, it is possible to grasp that the predetermined point is a point characterized by the center of buoyancy. In this way, the positioning system 1 makes it possible to grasp the state of a predetermined point of the ship 10.

### Variation 1

In this embodiment, the coordinate system used for the reference vector is a latitude, longitude, and altitude coordinate system. However, the coordinate system used for the reference vectors may be other than that defined by latitude, longitude, and altitude. For example, it may be a coordinate system in the direction of travel of the ship 10, the lateral direction of the ship 10, and the up-down direction of the ship 10, etc. Furthermore, the coordinate system used for the attitude, etc. of the ship 10 may be a coordinate system different from the coordinate system determined by latitude, longitude, and altitude. In this case, the computing device 100 calculates the position of the predetermined point by appropriately performing coordinate conversion.

### Variation 2

In this embodiment, the position of a predetermined point of the ship is calculated. That is, in this embodiment, the position of a predetermined point of the moving body of the floating body is calculated.

However, this embodiment can also be applied to floating bodies that do not move, such as offshore wind power generation facilities. In this case, the amount of change in the position of the floating body due to the oscillation coincides with the amount of change in the position of the floating body. Therefore, the center of buoyancy of the floating body can be identified without taking into account the amount of movement.

Furthermore, the floating body (moving body) may be an object that floats in the air, such as an airplane or a drone.

Furthermore, the vehicle oscillates due to vibrations while traveling or acceleration (forward/rearward or lateral acceleration) that occurs while traveling. Furthermore, buildings also oscillate due to the effects of earthquakes or wind. Therefore, this embodiment can also be applied to objects other than floating bodies such as vehicles or buildings. In this case, it is assumed that the point where the amount of change due to the oscillation of the object is the smallest is the center of gravity. Therefore, the computing device 100 identifies the center of gravity of the object based on the amount of change in the position of the object due to the oscillation.

### Variation 3

In this embodiment, the computing device 100 is directly connected to the first antenna 210, the second antenna 220, and the third antenna 230. However, the connection with the antenna need not be limited to this example. In another example, the computing device 100 may be indirectly connected to at least one of the first antenna 210, the second antenna 220, and the third antenna 230 via one or more external computers such as a relay device.

### Variation 4

In addition, when the current position of at least one of the first antenna 210, the second antenna 220, and the third antenna 230 cannot be obtained, the computing device 100 may obtain the attitude of the ship 10 using an inertial measurement unit. Here, the inertial measurement unit is mounted on a ship 10. Then, the computing device 100 acquires the current position of the antenna, among the first antenna 210, the second antenna 220, or the third antenna 230, whose current position can be acquired, and modifies the reference vector from that antenna to a predetermined point according to the current attitude of the ship 10 at the current position of that antenna. The computing device 100 may obtain the current position of the inertial measurement unit and modify the reference vector from the inertial measurement unit to a predetermined point. In this way, even if the current position cannot be acquired from all three antennas, the exact position of the predetermined point can be ascertained.

### Other Embodiments

The above-described embodiment is merely an example, and the present disclosure can be modified as appropriate without departing from the spirit and scope of the present disclosure. Furthermore, the processes and means described in this disclosure can be freely combined and implemented as long as no technical contradiction occurs.

Furthermore, the processes described as being performed by one device may be shared and executed by a plurality of devices. Alternatively, the processes described as being performed by different devices may be performed by a single device. In a computer system, the hardware configuration (server configuration) by which each function is realized can be flexibly changed.

The present disclosure can also be realized by supplying a computer program implementing the functions described in the above embodiments to a computer, and having one or more processors of the computer read and execute the program. Such a computer program may be provided to the computer by a non-transitory computer-readable storage medium connectable to the system bus of the computer, or may be provided to the computer via a network. A non-transitory computer-readable storage medium includes any type of medium suitable for storing electronic instructions, such as, for example, any type of disk, such as a magnetic disk (such as a floppy disk or a hard disk drive (HDD)), an optical disk (such as a CD-ROM, a DVD disk, or a Blu-ray disk), a read-only memory (ROM), a random-access memory (RAM), an EPROM, an EEPROM, a magnetic card, a flash memory, or an optical card.

What is claimed is:

1. A positioning system comprising a first positioning antenna, a second positioning antenna and a third positioning antenna attached to an oscillating body,
and a computing device, wherein
the computing device is configured to execute;
acquiring a first position measured by the first positioning antenna, a second position measured by the second positioning antenna, and a third position measured by the third positioning antenna,
calculating a current attitude of the oscillating body at the first position from a first vector from the first position to the second position and a second vector from the first position to the third position,
modifying a reference vector from the first positioning antenna to a predetermined point in the attitude of the oscillating body at a predetermined time in accordance with the calculated current attitude of the oscillating body at the first position, and
calculating a position of the predetermined point in the current attitude of the oscillating body by adding the modified reference vector to the first position.

2. The positioning system of claim 1, wherein the predetermined point comprises a point on a surface of the oscillating body.

3. The positioning system according to claim 1, wherein
the oscillating body is a moving body, and
calculating the position of the predetermined point includes calculating positions of a plurality of predetermined points of the oscillating body, and
the calculation device is configured to further execute; acquiring an amount of change in position for the plurality of predetermined points,
calculating an amount of change due to the oscillation of the oscillating body for the plurality of predetermined points by removing an amount of change due to the movement of the oscillating body from the amount of change in position for the plurality of predetermined points,
acquiring a transition in the amount of change due to the oscillation of the oscillating body for the plurality of predetermined points, and
identifying a point among the plurality of predetermined points with the smallest amount of change due to the oscillation of the oscillating body as the center of buoyancy or center of gravity of the oscillating body, referring to the transition in the amount of change due to the oscillation of the oscillating body.

4. The positioning system according to claim 1, wherein
the oscillating body is not a moving body, and
calculating the position of the predetermined point includes calculating positions of a plurality of predetermined points of the oscillating body, and
the calculation device is further configured to execute; acquiring a transition of an amount of change due to the oscillation of the oscillating body for the plurality of predetermined points,
identifying a point among the plurality of predetermined points with the smallest amount of change due to the oscillation of the oscillating body as the center of buoyancy or center of gravity of the oscillating body, referring to the transition in the amount of change due to the oscillation of the oscillating body.

5. A non-transitory storage medium storing a positioning program that causes a computing device connected to a first positioning antenna, a second positioning antenna, and a third positioning antenna attached to an oscillating body to execute an information processing method, wherein
the information processing method includes;
acquiring a first position measured by the first positioning antenna, a second position measured by the second positioning antenna, and a third position measured by the third positioning antenna,
calculating a current attitude of the oscillating body at the first position from a first vector from the first position to the second position and a second vector from the first position to the third position,
modifying a reference vector from the first positioning antenna to a predetermined point in the attitude of the oscillating body at a predetermined time in accordance with the calculated current attitude of the oscillating body at the first position, and
calculating a position of the predetermined point in the current attitude of the oscillating body by adding the modified reference vector to the first position.
